(19) United States
(12) Patent Application Publication
(10) Pub. No.: US 2007/0162848 A1
(43) Pub. Date: Jul. 12, 2007

(54) Predictive styling

(75) Inventors: Philip Andrew Mansfield, Vancouver (CA); Roger Rosner, Mountain View, CA (US); Richard Cave, Camas, WA (US); Christopher Rudolph, Camas, WA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Computer, Inc.

(21) Appl. No.: 11/330,417

(22) Filed: Jan. 9, 2006

(51) Int. Cl. G06F 17/00

(52) U.S. Cl. 715/539; 715/530; 715/531; 715/500

(57) ABSTRACT

Determining a style attribute is disclosed. An indication of a new object to be added to a content document associated with a template data is received. The style attribute for the new object is determined based at least in part on the template data.

### BACKGROUND OF THE INVENTION

Templates include predefined layout and/or styling used in content authoring. For example, a template for a newsletter includes predefined columns, text boxes, and placeholder items to be replaced with a user specified image. By predefining layout of objects used in content authoring, the author of a document can create content without being overly occupied by styling and layout of the document. In some cases, the predefined objects of the template are not sufficient for a desired document to be created. Typically when new objects are added to a document associated with a template, the styling of the new object does not match the styling of the other objects predefined by the template. For every new object added, the author must tediously restyle the new object to match the style of the template. Therefore, there exists a need to more efficiently style a new object added to a document associated with a template.

### BRIEF DESCRIPTION OF THE DRAWINGS

Various embodiments of the invention are disclosed in the following detailed description and the accompanying drawings.

FIG. 1 is a flow chart illustrating an embodiment of a process for providing behaviors.

FIG. 2 is a flow chart illustrating an embodiment of a process for providing a document associated behavior.

FIG. 3 is a flow chart illustrating an embodiment of a process for rendering a document.

FIG. 4 is a diagram illustrating an embodiment of a process for performing a document associated behavior.

FIG. 5 is a flow chart illustrating an embodiment of a process for performing a behavior.

FIG. 6 is a diagram illustrating an example of a document structural information.

FIG. 7 is a diagram illustrating an example of a document page.

FIG. 8 is a diagram illustrating an example of a document page.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Determining a style attribute is disclosed. In some embodiments, when a new object is added to a document associated with a template, a style attribute for the new object is determined using the template. The template, in various embodiments, contains one or more styling rules for new objects added to the document. In some embodiments, template data is stored together with the document in the same file or template data is stored in a separate linked file associated with a file containing the document contents. In some embodiments, the style attribute specifies one or more styling properties of the new object, and the styling properties include one or more of the following: a color, a shading, a size, a font, an alignment, an orientation, a spacing, an sorting order, a predefined style, a paragraph style attribute, a cell style attribute, a table style attribute, a chart style attribute, an image style attribute, an audio style attribute, a video style attribute, a multimedia style attribute, a presentation style attribute, and a database style attribute. In some embodiments, the style attribute specifies one or more user interface properties associated with one or more of the following: a menu bar, a tool bar, a menu item, and a context sensitive menu. In some embodiments, the document includes one or more of the following: a word processing content, a spread sheet content, a presentation content, visual graphic content (e.g. chart, graph, map, drawing, image content), an audio content, a multimedia (e.g. video content) content, a XML (Extensible Markup Language) content, a HTML (Hyper Text Mark-Up Language) content, a XSL (Extensible Stylesheet Language) content, a CSS (Cascading Style Sheets) content, and a database content. In some embodiments, template-associated behaviors other than styling, such as a user interface behavior, is provided.

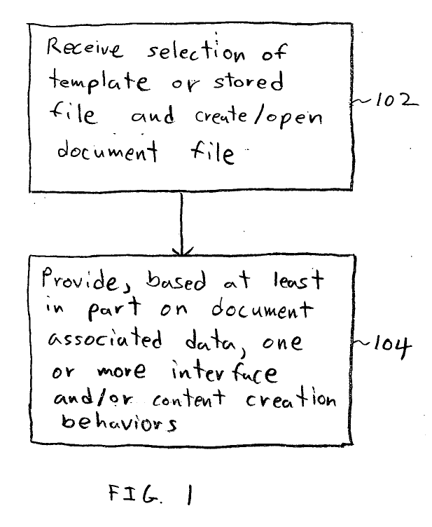

FIG. 1 is a flow chart illustrating an embodiment of a process for providing behaviors. At 102, a selection of template or store file is received, and a document file is created or opened. In some embodiments, receiving the selection of the template and creating the file are associated with creating a new document, and receiving the selection of the stored file and opening the file are associated with opening an already created document. The stored file is associated with a template. The created file is associated with the selected template. In various embodiments, the selection is received by a content creation/editing application, and the file is created/opened by the application. The document file, in some embodiments, includes content data and data associated with document-specific behaviors. For example, the document file includes data associated with one or more content objects comprising a document and data associated with interface and/or content creation behaviors preformed when modifying the document. In some embodiments, the document file includes template data associated with the document. The template data, in some embodiments, includes style and/or user interface behavior(s) for object(s) that are not yet added to the document. By including additional data beyond content data in the document file, the document file, in various embodiments, can be transferred to another content creation/editing application without the originating template installed. User interface and/or document modification/creation continues to behave in a manner of the original template by using data included in the document file. In some embodiments, the document file is a logical document file stored in one or more physical files. For example, a first file containing the content data and a second file containing the document-specific behaviors are associated in a manner that enables both file to be always accessible together. By moving the first or the second file to a new storage location, the other file is automatically moved/modified to allow both files to be accessible together. At 104, one or more interface and/or content creation behaviors are provided based at least in part on document associated behaviors. For example, when a new table content object is added, the table's colors, borders, and header row/column styling, as well as, user interface menu times, toolbars, and/or interface functionality are automatically defined using a style of the template associated with the document.

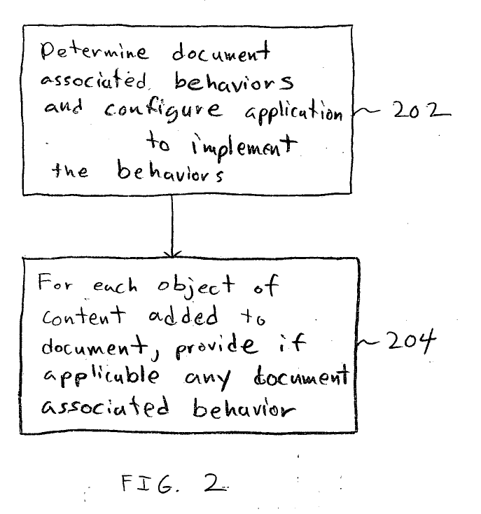

FIG. 2 is a flow chart illustrating an embodiment of a process for providing a document associated behavior. In some embodiments, the process of FIG. 2 is included in 104 of FIG. 1. At 202, one or more document associated behaviors are determined, and an application is configured to implement the behaviors. In some embodiments, determining the document associated behaviors includes reading data associated with the behaviors from a document file. The data associated with the behaviors includes one or more of the following: a configuration parameter/value, a user interface/display data, a rule/logic associated one or more content objects, and data associated with one or more new objects that can be added into a document. Examples of the application include any application that can be used at least in part to create, modify, and/or view document content. At 204, for each object of content added to a document, any document associated behavior, if applicable, is provided. The document associated behavior is at least in part associated with at least a portion of behaviors determined in 202. In some embodiments, document associated behavior is not provided when no behavior is defined for the specific instance of the new object.

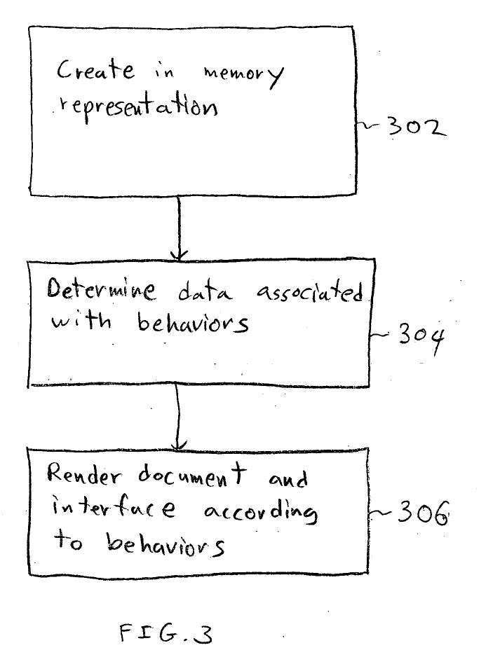

FIG. 3 is a flow chart illustrating an embodiment of a process for rendering a document. In some embodiments, the process of FIG. 3 is included in 202 of FIG. 2. At 302, an in-memory representation is created. In some embodiments, the creating the in-memory representation includes creating one or more representations in memory of at least a portion of the document. For example, a document file is read and processed to create a memory representation of the document contents for use by one or more applications. In some embodiments, a data structure (e.g., document structure tree) is created when creating the in-memory representation of the document. At 304, data associated with behaviors are determined. The behaviors are associated with the document. In some embodiments, determining the data associated with the behaviors includes performing one or more of the following: reading data associated with the behaviors from a document file, determining behaviors from template data, creating one or more representations in memory of one or more document associated behaviors, and using data associated with the behaviors to configure an application. At 306, the document and interface are rendered according to the determined behaviors. Rendering the interface, in some embodiments, is optional. In various embodiments, rendering the interface includes rendering one or more of the following: a menu bar, a tool bar, one or menu items, a context sensitive menu, and any user interface items. The behaviors specify one or more properties associated with the interface. In some embodiments, rendering the document includes processing objects contained in the document for displaying the document.

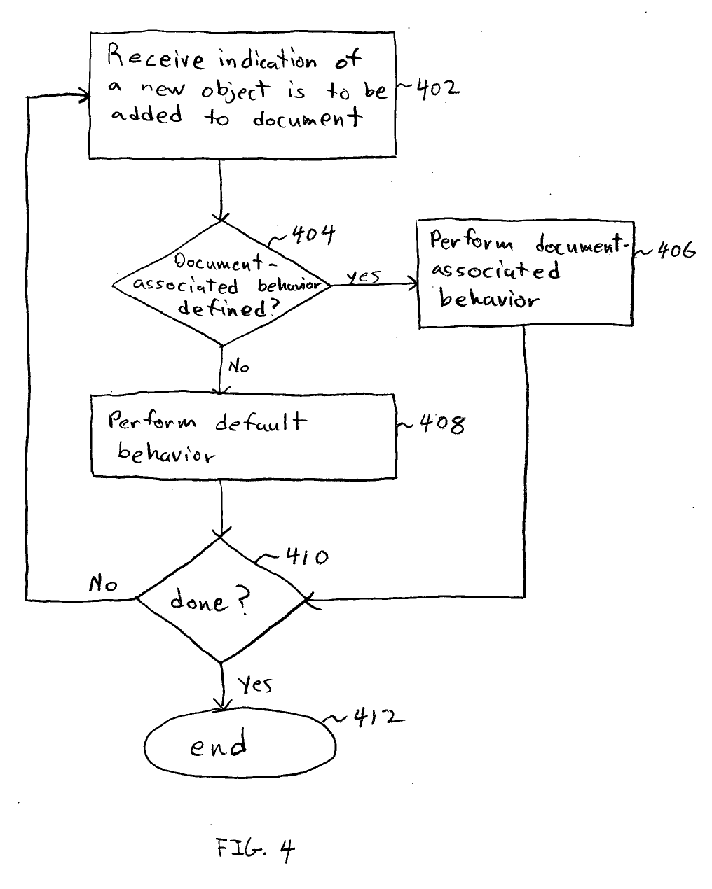

FIG. 4 is a diagram illustrating an embodiment of a process for performing a document associated behavior. In some embodiments, the process of FIG. 4 is included in 204 of FIG. 2. At 402, an indication of a new object to be added to a document is received. The object, in various embodiments, includes one or more of the following: a text, a text box, an equation, a shape, a drawing, an image, a matrix, a photo matrix a table, a chart, an audio, a video, and any document content object. In some embodiments, the indication is received at least in part from a script, a macro, a wizard, an input device, an automatic process, and/or a selection or an indication of a user interface item associated with the new object. If at 404 it is determined a document associated behavior is defined, at 406, the defined document associated behavior is performed. Determining if the document associated behavior is defined, in some embodiments, includes using template data associated with the document. In some embodiments, the configuration of application in 202 of FIG. 2 and/or the data associated with behaviors in 304 of FIG. 3 is at least in part used in determining if the document associated behavior is defined. Performing the document associated behavior includes performing a behavior associated with the new object. For example, a style attribute for the new object based at least in part on a template data is determined and/or a user interface item is provided based on the new object. In some embodiments, performing the document associated behavior includes modifying one or properties of one or more existing objects of the document. In some embodiments, the behavior is associated with a defined rule, script, logic, and/or configuration. If at 404 it is determined a document associated behavior is not defined, a default behavior is performed. In some embodiments, the default behavior is predetermined and/or configurable using one or more of the following: an application configuration data, a template data, a user specified data, and a default configuration data. If at 410 done is not determined, at 402, an indication of a new object is received. If at 410 done is determined, at 412, the process ends. In some embodiments, the done determination is associated with closing the document, exiting an application associated with the document, saving the document, and/or an interruption of the process of FIG. 4. In some embodiments, end of the process of FIG. 4 is associated with saving the document. In various embodiments, document contents are saved together with template data and/or data associated with document-specific behaviors.

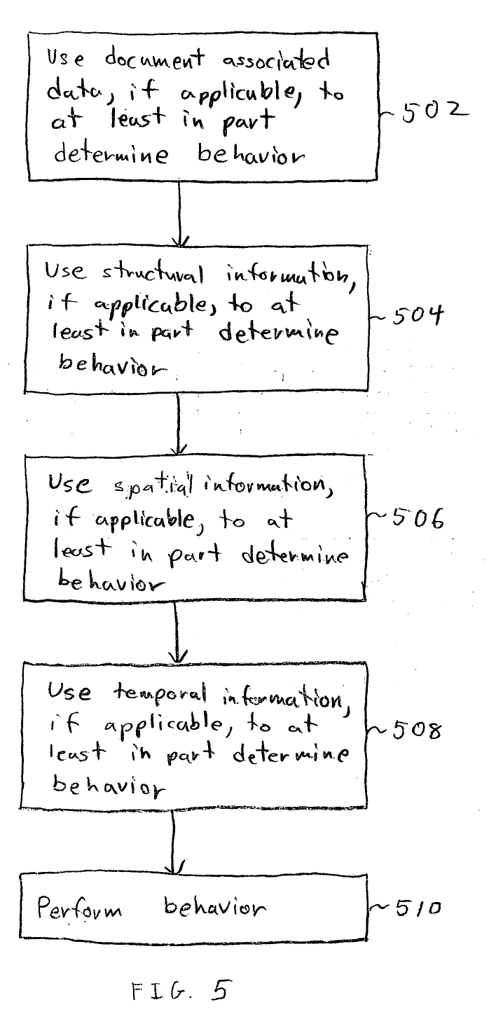

FIG. 5 is a flow chart illustrating an embodiment of a process for performing a behavior. The behavior is associated with a new object to be added to a document. In some embodiments, the process of FIG. 5 is included in 406 of FIG. 4. At 502, document associated data is used, if applicable, to at least in part determine the behavior. In some embodiments, the document associated data includes at least a portion of data determined in 304 of FIG. 3. At 504, structural information of the document, if applicable, is at least in part used to determine the behavior. In some embodiments, the structural information includes a program data structure representation of the document. For example, the document can be represented as a hierarchical tree of objects. By placing of the new object within the hierarchical tree, one or more style attributes and/or interface behaviors associated with a parent object, a sibling object, and/or a child object is used at least in part to perform the behavior associated with the new object. At 506, spatial information, if applicable, is used at least in part to determine the behavior. In some embodiments, the spatial information is associated with the location of the new object and/or the spatial relationship with respect to other objects. For example, a template associated with the document includes a “marginal note” region and a “vignette” region. A new paragraph object that is entered within the marginal note region will be style differently from one that is entered in the vignette region. The marginal note paragraph will be aligned right if the marginal note is in the left margin, but the marginal note paragraph will be aligned left if it is in the right margin. When the marginal note is added inside a list, the marginal note will always be aligned left. The vignette region paragraph will span one column if placed inside a column, but the vignette region will span two columns if placed in between two columns. At 508, temporal information, if applicable, is used at least in part to determine behavior. For example, one or more style attributes of a recently added or modified object is at least in part use to style the new object. At 510, the behavior is performed.

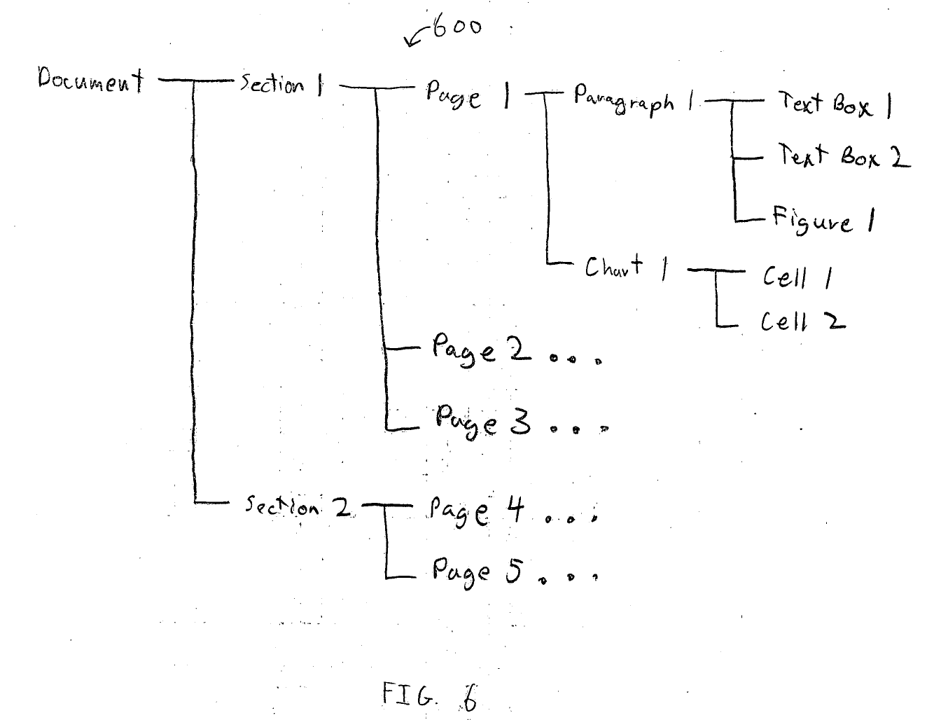

FIG. 6 is a diagram illustrating an example of a document structural information. In some embodiments, document structure tree 600 is at least in part used in 504 of FIG. 5. In some embodiments, document structure tree 600 is at least in part created in 302 of FIG. 3. Document structure 600 includes objects organized in a hierarchical data structure. The objects include container objects that can be associated with one or more child objects. The objects in tree 600 are merely illustrative. Other and/or different objects may exist in tree 600. In some embodiments, when a new object is added to a document associated with tree 600, the new object is placed in tree 600 based at least in part on the location of the new object within the document. For example when a new text box is added to a first paragraph in a first page, the new text box added under “Document→Section 1→Page 1→Paragraph 1.” A document associated behavior is performed when the new text box is added. The behavior is determined at least in part on the document structure tree. One or more style attributes and/or interface behaviors associated with a parent object (e.g., Document, Section 1, Page 1, and/or Paragraph 1), a sibling object (Text Box 1, Text Box 2, and/or FIG. 1), and/or a child object is used to perform the behavior. For example, a color style attribute associated with paragraph 1 is used to style to the new text box.

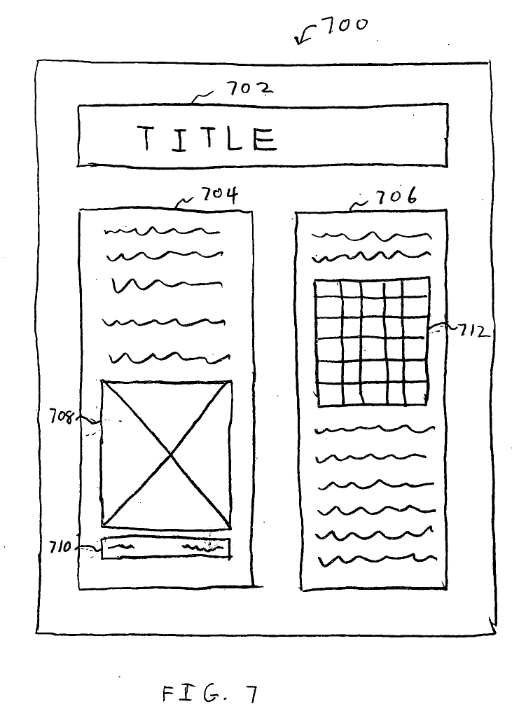

FIG. 7 is a diagram illustrating an example of a document page. Document page 700 is associated with a template. The original template included title text box 702, first column 704, and second column 706. New image object 708, new caption text box 710, and new table 712 have been added to the document page. In a document structure information associated with document page 700, new image object 708 and a new caption text box 710 are-children of first column 704, and new table 712 is a child of second column 706. When the new image object 708, new caption text box 710, and new table 712 were added, one or more style attributes of the new objects were determined by a document-specific behavior based on the document structure information. For example, the color, borders, and header row/column styling of table 712 were at least in part determined using the document structure information. This determination, in some embodiments, is made at 504 of FIG. 5. In some embodiments, text box 710 was added immediately after image object 708 was added. Due to the temporal and spatial relationship between image object 708 and text box 710, text box 710 is automatically associated with image 708 and styled as a caption text box by a document-specific behavior. The determination of the temporal and spatial relationship is made, in some embodiments, at 506 and 508 of FIG. 5.

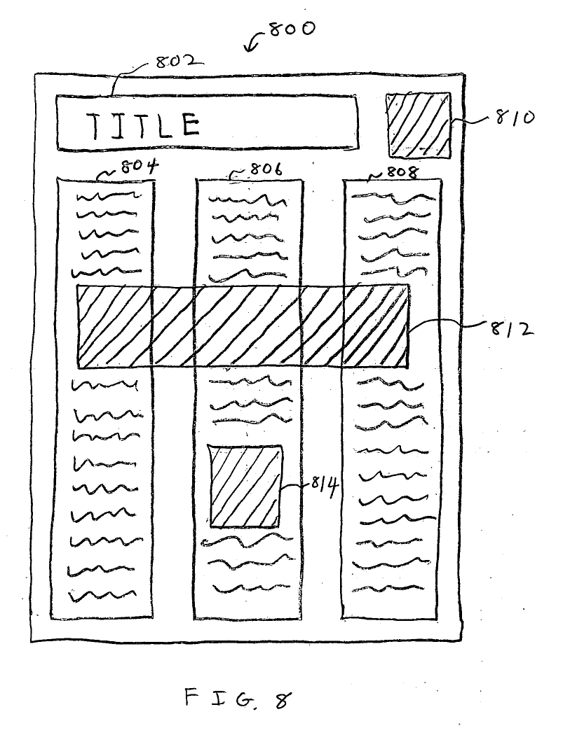

FIG. 8 is a diagram illustrating an example of a document page. Document page 800 is associated with a template. The original template included title text box 802, first column 804, second column 806, and third column 808. New object 810, new object 812, and new object 814 have been added to document page 800. Even though objects 810, 812, and 814 are of the same object type, the objects are automatically styled differently by document-specific behaviors at least in part due to their spatial location within the document. For example, a style attribute of new object 810 is at least in part determined due to the object's proximity to the corner of the document and adjacency to title 802. A style attribute of new object 812 is at least in part determined due to the object's overlap across columns 804, 806, and 808. A style attribute of new object 814 is at least in part determined due to the object's overlap within only one column. In some embodiments, the document-specific behaviors associated with spatial locations are determined in 506 of FIG. 5.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of determining a style attribute, comprising:
receiving an indication of a new object to be added to a content document associated with a template data; and
determining the style attribute for the new object based at least in part on the template data.

2. A method as recited in claim 1, wherein the template data includes one or more styling rules for objects not yet added to the content document.

3. A method as recited in claim 1, wherein determining the style includes performing a behavior associated with the new object, and the behavior is based at least in part on the template data.

4. A method as recited in claim 1, wherein structural information of the document, if applicable, is at least in part used to determine the style attribute.

5. A method as recited in claim 4, wherein the structural information includes a tree or other hierarchical data structure representation of the document.

6. A method as recited in claim 5, wherein the style attribute is associated with a parent object, a sibling object, or a child object of the new object in the tree or other hierarchical data structure representation.

7. A method as recited in claim 1, wherein spatial information of the new object, if applicable, is at least in part used to determine the style attribute.

8. A method as recited in claim 7, wherein the spatial information is associated with a location of the new object within the document or a spatial relationship between the new object and one or more other objects of the document.

9. A method as recited in claim 1, wherein temporal information associated with the document, if applicable, is at least in part used to determine the style attribute.

10. A method as recited in claim 9, wherein the temporal information includes one or more style attributes of a recently added or modified object.

11. A method as recited in claim 1, wherein the content document and the template data are stored together in a single file.

12. A method as recited in claim 1 1, wherein the file includes data associated with one or more document-specific behaviors.

13. A method as recited in claim 12, wherein the document-specific behaviors include user interface or content creation behaviors performed when new objects are added to the document.

14. A method as recited in claim 12, wherein the data associated with the document-specific behaviors includes one or more of the following: a configuration parameter/value, a user interface/display data, a rule/logic associated one or more content objects, and data associated with one or more new objects that can be added to the document.

15. A method as recited in claim 1, wherein the content document and the template data are stored together in one or more linked files that are accessible together.

16. A method as recited in claim 1, wherein determining the style attribute for the new object includes determining if the template data defines the style attribute for the new object.

17. A method as recited in claim 16, wherein when the template data does not define the style attribute, the style attribute is associated with a default style attribute.

18. A method as recited in claim 17, wherein the default style attribute is configurable using one or more of the following: an application configuration data, the template data, and a user specified data.

19. A method as recited in claim 1, wherein the indication is received by an application configured to create, modify, or view the document.

20. A method as recited in claim 1, wherein the indication is received at least in part from one or more of the following: a script, a macro, a wizard, an input device, an automatic process, and a selection or indication of a user interface item associated with the new object.

21. A method as recited in claim 1, wherein the style attribute includes one or more of the following: a color, a shading, a size, a font, an alignment, an orientation, a spacing, an sorting order, a predefined style, a paragraph style attribute, a cell style attribute, a table style attribute, a chart style attribute, an image style attribute, an audio style attribute, a video style attribute, a multimedia style attribute, a presentation style attribute, and a database style attribute.

22. A method as recited in claim 1, wherein the new object includes one or more of the following: a text, a text box, an equation, a shape, a drawing, an image, a matrix, a photo matrix, a table, a chart, an audio, and a video.

23. A method as recited in claim 1, wherein the style attribute includes one or more user interface properties associated with one or more of the following: a menu bar, a tool bar, a menu item, and a context sensitive menu.

24. A method as recited in claim 1, wherein the content document includes one or more of the following: a word processing content, a spread sheet content, a presentation content, visual graphic content (e.g. chart, graph, map, drawing, image content), an audio content, a multimedia (e.g. video content) content, a XML (Extensible Markup Language) content, a HTML (Hyper Text Mark-Up Language) content, a XSL (Extensible Stylesheet Language) content, a CSS (Cascading Style Sheets) content, and a database content.

25. A system for determining a style attribute, comprising:
a processor configured to receive an indication of a new object to be added to a content document associated with a template data, and determine the style attribute for the new object based as least in part on the template data; and
a memory coupled to the processor.

26. A system as recited in claim 25, wherein the template data includes one or more styling rules for objects not yet added to the content document.

27. A system as recited in claim 25, wherein to determine the style attribute for the new object, one or more of the following is used: a structural information of the document, a spatial information of the document, and a temporal information of the document.

28. A system as recited in claim 25, wherein the content document and the template data are stored together in a single file.

29. A system as recited in claim 28, wherein the single file includes data associated with one or more document-specific behaviors, and the document-specific behaviors include user interface or content creation behaviors performed when new objects are added to the document.

30. A computer program product for determining a style attribute, the computer program product being embodied in a computer readable medium and comprising computer instructions for:
receiving an indication of a new object to be added to a content document associated with a template data; and
determining the style attribute for the new object based at least in part on the template data.
